(19) United States
(12) Patent Application Publication
(10) Pub. No.: US 2008/0065249 A1
(43) Pub. Date: Mar. 13, 2008

(54) METHOD AND APPARATUS FOR AD HOC SHARING OF MEDIA SAMPLES

(76) Inventor: STEPHEN Y. PANG, Menlo Park, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/851,390

(22) Filed: Sep. 7, 2007

Related U.S. Application Data
(60) Provisional application No. 60/825,105, filed on Sep. 8, 2006.

(51) Int. Cl. G06F 17/00

(52) U.S. Cl. 700/94

(57) ABSTRACT

A method for a media player comprises requesting from a remote media player a sample of a media track stored on the remote media player, receiving the sample of the media track and an identifier associated with the media track from the remote media player, wherein the sample of the media track is determined in the remote media player in response to the media track, and wherein the sample of the media track is less than all of the media track, purchasing the media track from a media server in response to the identifier associated with the media track, and downloading the media track from the media server.

### CROSS-REFERENCES TO RELATED APPLICATIONS

This application claims priority to U.S. Provisional Patent Application No. 60/825,105, filed Sep. 8, 2006, commonly assigned, incorporated by reference herein for all purposes.

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND OF THE INVENTION

The present invention relates to sharing of media. More specifically, the present invention relates to controlled sharing of samples of media on an ad hoc basis between users.

Unauthorized sharing of media, such as music, video, textual works, or the like, between users has been a large concern to media producers, such as authors, singers, media companies, publishers and the like. Attempts to control or restrict sharing of such media has mainly been via technological means, e.g. digital rights management DRM methods, and via legal channels, e.g. law suits, and seizures.

However it is now being understood or believed by some that some level of “unauthorized” sharing of media between users may actually increase the market for that media. For example, it is argued, if A introduces and “shares” music from a Band X with B and C, B and C may like the music and go out and buy additional music from Band X. Then, in the end, despite A being unauthorized to share music with B and C, Band X will sell more music.

A problem with this “sharing” of media, other than the copyright issues, is that often the other parties who get the “shared” media do not purchase the media. Instead, the shared media replaces a purchase of the media. Thus, using the example above, Band X will not sell more music.

A solution considered by the inventor for sharing media include where the “shared” media has an expiration date. For example, A could share media with B, however, the media will “expire” or become unlistenable in a day, three days, or the like.

Problems to such a solution is that it requires the customer's hardware to have functionality to monitor the shared media, and to cause the shared media to “expire.” It is believed that the addition of such “enforcement” hardware is resented by users. Additionally, it is believed that the addition of such hardware and software will disadvantageously contribute to a higher-priced media playback device.

Still another problem is that often users will want to use the media for a short amount of time, and thus sharing media for a day or so, fulfills the user's desire to purchase the media. Accordingly, in the example above, after B and C watch/listen to different Band X music for several days, they will have no desire to purchase the same Band X music, and thus, Band X will not sell more music.

In light of the above, the inventor of the present invention has determined that what is desired is a simple method and apparatus that allows users to share media on an ad hoc basis, without providing the entire media to the receiving party.

### SUMMARY OF THE INVENTION

The present invention relates to sharing of media samples. More specifically, the present invention relates to controlled sharing of media, in the form of samples of media, between users.

Embodiments of the present invention encourage users to share media samples with other parties. Based upon the samples, users are encouraged to download their own copies of the sampled media. In various embodiments, the users who share media with other users may be compensated when the other users purchase the full media. In other words, it encourages users to become advertisers or promoters of the media.

According to one aspect of the invention, a method for a portable audio player is described. One process includes requesting from a remote portable audio player a sample of an audio track stored on the remote portable audio player, and receiving the sample of the audio track and an identifier associated with the audio track from the remote portable audio player, wherein the sample of the audio track is determined in the remote portable audio player in response to the audio track, and wherein the sample of the audio track is less than all of the audio track. A method may include purchasing the audio track from an audio server in response to the identifier associated with the audio track, and downloading the audio track from the audio server.

According to another aspect of the invention, a method for a portable media player is disclosed. A technique may include receiving a selection of a button on the portable media player by a user of the portable media player, and determining a media track in response to the selection of the button. Processes may include determining a sample media track from the media track in response to the selection of the button, and transmitting the sample media track, but not the media track, to a remote portable media player.

According to yet another aspect of the invention, a portable media player is described. One apparatus includes a memory configured to store a media file, and a wireless transmitter portion configured to transmit data to a remote portable media player. a device may include a user-selectable input configured to determine a user selection, and a processor coupled to the memory, the wireless transmitter, and the user-selectable input. The processor may be configured to determine a sample portion of the media file in response to a selection by the user of the user-selectable input, and may be configured to output the sample portion of the media file, but not the media file, to the wireless transmitter portion in response to the selection of the user-selectable input.

### BRIEF DESCRIPTION OF THE DRAWINGS

FIG. 1 is a simplified block diagram of a system according to an exemplary embodiment of the present invention;

FIGS. 2A-D illustrates a block diagram of a process according to some embodiments of the present invention; and

FIGS. 3A-B illustrates block diagrams of various embodiments of the present invention.

### DETAILED DESCRIPTION OF THE INVENTION

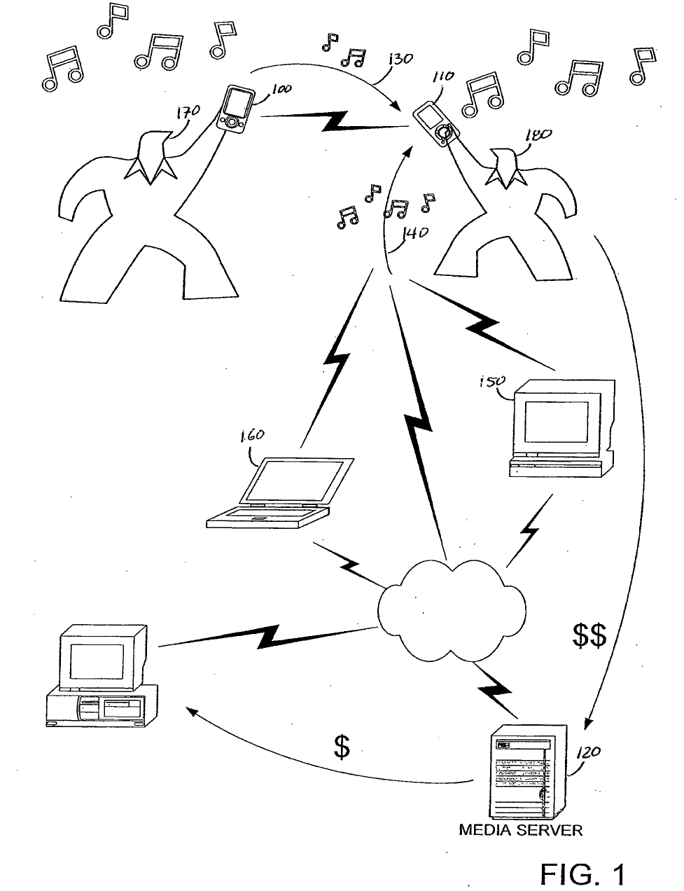

FIG. 1 is a simplified block diagram of a system according to an exemplary embodiment of the present invention. Specifically FIG. 1 illustrates a first device 100, a second device 110, and a media server 120. As illustrated, first device 100 and second device 110 may be coupled via a first communication channel 130. Additionally, second device 110 may be coupled via a second communication channel 140 to media server 120.

In various embodiments of the present invention, first device 100 and second device 110 are embodied as portable media devices, such as an audio player, a video player, or the like. In the future, some embodiments of the present may be incorporated into portable media devices available from companies such as Apple, Microsoft, SanDisk, Creative, Sony, Philips, Samsung, or the like. In various embodiments, first device 100 and second device 110 may have a dedicated hardware button, or a software defined button (e.g. a software defined hardware button, a selectable icon on a display, or the like), that enables sharing of media samples, as described below. Such a button may be termed a “share” button.

In various embodiments of FIG. 1, first device 100 and second device 110 both support communications via first communications channel 130. In various examples, first communication channel 130 may be a physical connection via one or more wires, an optical connection via infrared (e.g. IrDA) or via an optical link, a wireless connection, via Bluetooth, 802.11, WiFi, CDMA, GSM, Cellular, RF, or the like.

In various embodiments, second communications channel 140 between second device 110 and media server 120 may be similar to first communications channel 130. For instance, the communication may be wired, optical, wireless, or the like. In some embodiments of the present invention, second communications channel 140 may include one or more intermediary computers 150, 160. For instance, second communications channel 140 may be formed when a user couples second device 110 to a computer 150 or a wireless device/computer 160. In such cases, second communications channel 140 would include the path from computer 150 to media server 120, e.g. an Ethernet connection, or from wireless device/computer 160 to media server 120, e.g. WiFi, 802.11, CDMA, satellite, or the like. Additionally, second communications channel 140 may include a physical connection, e.g. via a USB cable, or the like, of second device 110 to intermediary computers 150, 160, or the like.

In some embodiments of the present invention, as will be described further below, first device 100 and second device 110 may be coupled via an ad hoc network via first communication channel 130 to communicate media data. In specific embodiments, the media data includes a sample clip of the media data, and not the entire media data. Additionally, the media data may include additional data regarding the media data. As will be described below, the additional data may include human-readable viewable regarding the media data, such as name of the media, images associated with the media (e.g. cover art), one or more links where the user may purchase the media, or the like.

In some embodiments of the present invention, as will also be described below, second device 110 and media server 120 may be coupled via second communications channel 140 to receive additional media data. In specific embodiments, the additional media data includes the entire media clip, and not a sample clip. For instance, via a media store, such as iTunes, or the like, a user of second device 110 may purchase and download the entire media clip. As will be described below, in some embodiments, the link sent by first device 100 is used by the user of second device 110 as a way to facilitate the purchase of the entire media clip. For instance, the link may be a hyperlink to the entire media clip at the iTunes store, the Yahoo store, or the like.

In some embodiments of the present invention, a link provided by first device 100 uniquely identifies the user 170 within media server 120. As will be described below, when a user 180 of second device 110 purchases media for media server 120 based upon the provided link, user 170 may be credited. The credit may take the form of monetary credit, point credit for user 170 for future downloads, or the like.

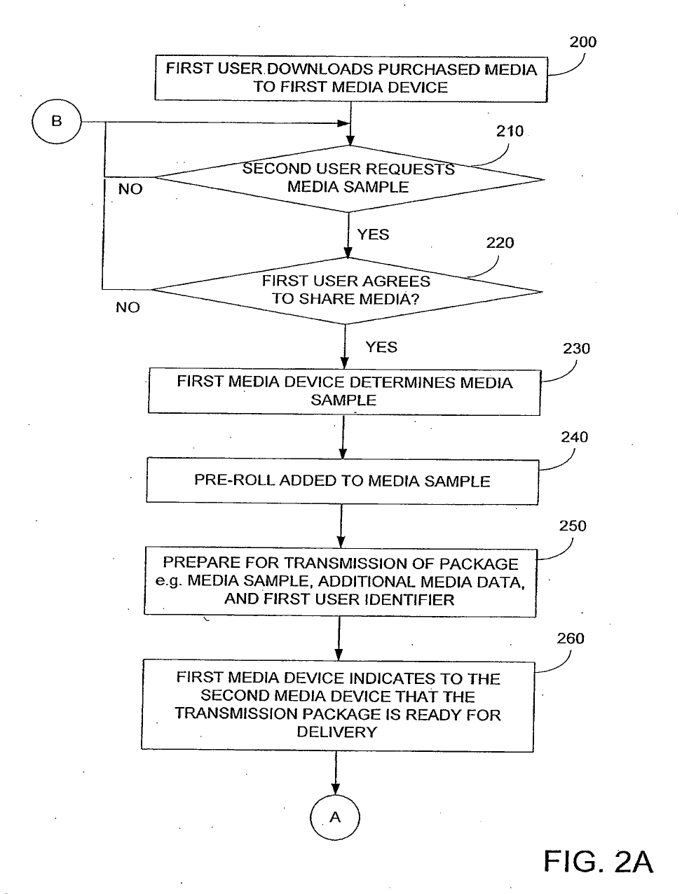

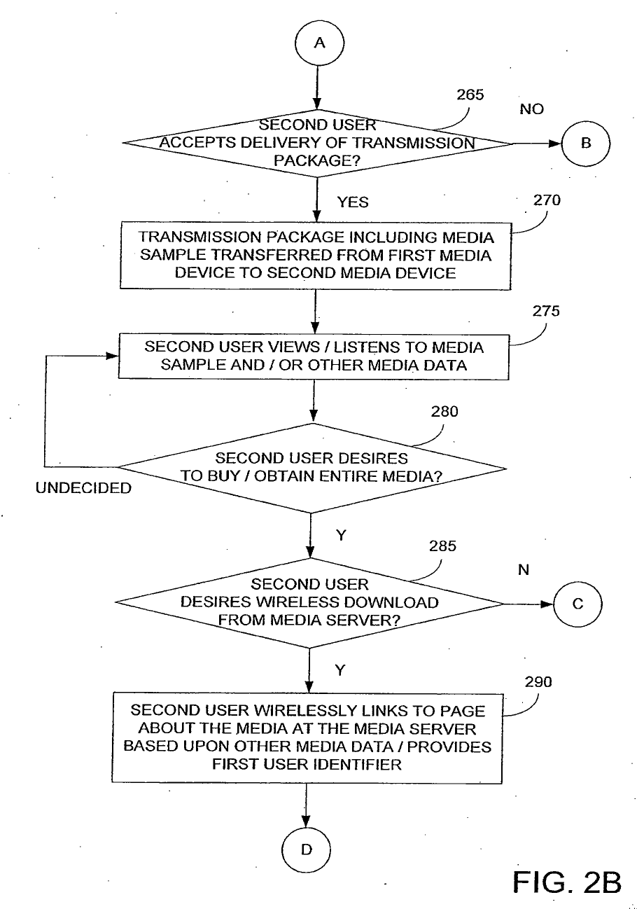

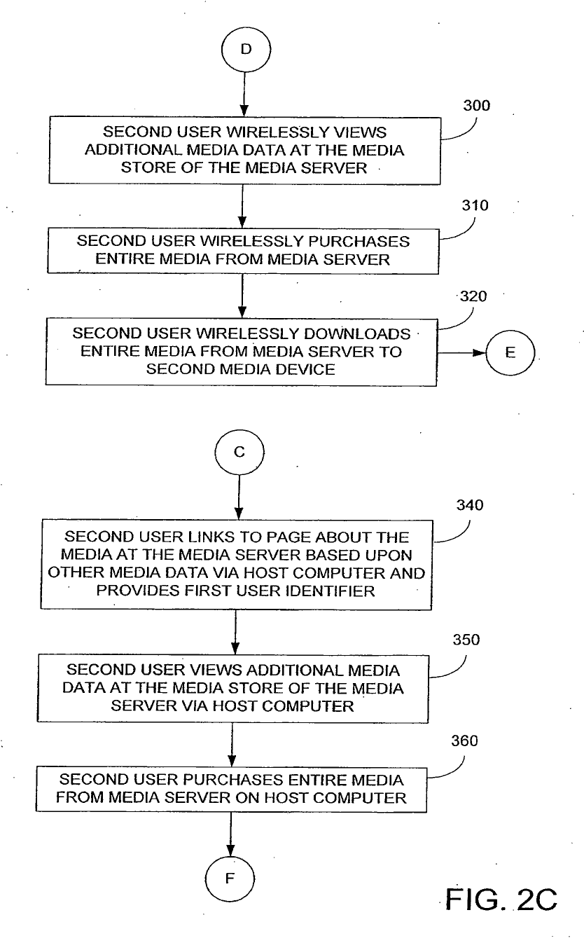

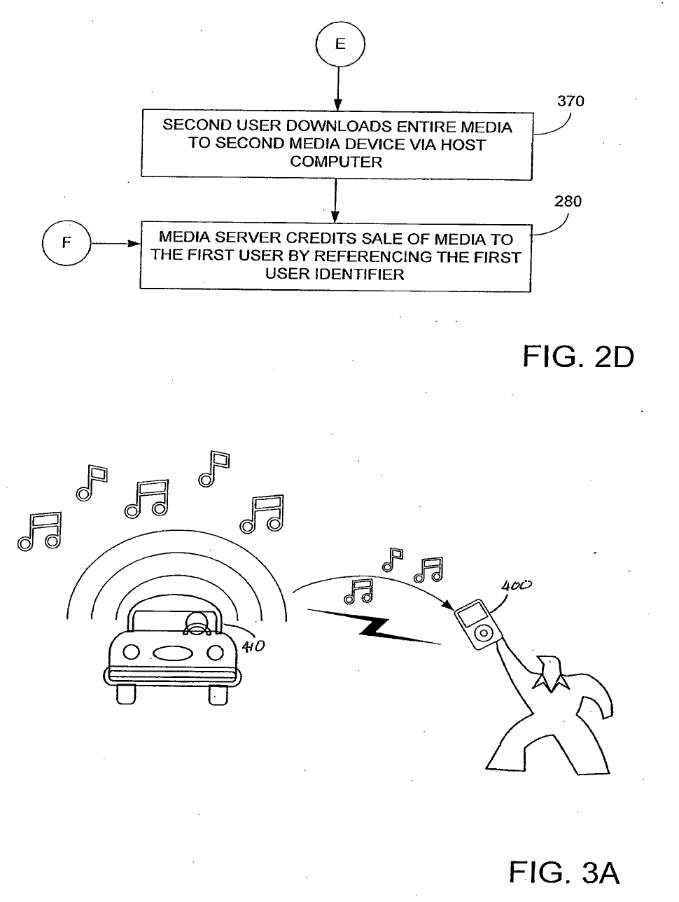

FIGS. 2A-D illustrates a block diagram of a process according to some embodiments of the present invention. For sake of clarity, a description of FIGS. 2A-D will be made with reference to the elements illustrated in FIG. 1.

Initially, user 170 purchases and downloads media from media server 120, step 200. In various embodiments, user 170 purchases the media via a media store associated with media server 120. Typically, the downloaded media includes the entire media clip, e.g. music, show, movie, or the like. Additionally, media server 120 may provide a pre-determined sample media clip, a link to the media clip at the media store, art associated with the media, textual descriptions of the media, or the like.

In some embodiments of the present invention, when the media clip is a television show, a movie, a short feature, or the like, the pre-determined sample media clip may be in the form of a teaser/trailer, an advertisement (e.g. commercial for a tv show), or the like. When the media clip is music, or the like, the pre-determined sample media clip may be the first thirty-seconds of the music, a middle thirty-seconds of the music, or the like. In such embodiments, media server 120 may specify the pre-determined sample media clip. In various embodiments of the present invention, the sample media clip need not be protected with digital rights management protection.

In other embodiments, no pre-determined sample media clip need be specified. In such embodiments, first device 110 determines the sample media clip, as will be described below.

In various embodiments of the present invention, media server 120 may provide first device 100 with a pre-formed link, e.g. a URL, or the like to the media at the media store. In various embodiments, the pre-formed link may include an identifier that uniquely identifies user 170 to media server 120. As will be described below, when the pre-formed link is resolved, the source of the click is attributed to user 170.

In some embodiments of the present invention, additional data associated with the media may include images, such as album covers, DVD covers, or the like. Additionally, short informational text may also be provided, such as song name, movie name, episode name, artist, and the like.

In some embodiments of the present invention, not all of the above data about the media need be provided, to reduce “overhead” for the media download. For example, for any media, the additional data may be as little as a numeric identifier of the media which identifies the media within media server 120, the filename of the media (e.g. “Sample_James_Taylor_Everyday.mp3”, “Sample_Quantum_Leap_Evil Leaper.mov”), or the like.

In various embodiments, user 170 may purchase the media from media server 120 via any of the communications channel described above. For example, user 170 may purchase the media wirelessly via WiFi, 802.11x, CDMA, RF, or the like with wireless capability provided in some embodiments of first device 100. As another example, user 170 may purchase the media via a home computer, and download the media from the computer to first device 100 via a USB cable, or the like.

In various embodiments, first device 100 and second device 110 may have a common communications capability, as illustrated as first communications channel 130, as described in FIG. 1. For example, first communications channel 130 may include a wireless or wired ad hoc network.

Next, in various embodiments, user 180 desires to see or hear what user 170 is watching or listening, and presses a “share” button on second device 120, step 210. In this step, in response to the share button, second device 110 may send a share request to first device 100 via first communications channel 130. After user 170 sees the request, and decides to share the media she is currently viewing/listening to, user 170 may also press the share button to accept the request to share the media, step 220.

In some embodiments, if user 170 is not interested in sharing or does not see the share request, additional requests from second device 110 may be ignored for a predetermined period of time, e.g. 10 minutes. Such a step may be desired to reduce nuisance requests to share music.

In other embodiments, user 180 may walk up to user 170 and ask user 170 to send her a sample clip. Accordingly, step 210 need not be performed in all embodiments. In response to the request, user 170 may electronically initiate the process by pressing the share button, as described in step 220, above.

In some embodiments, in response to user 170 pressing the share button, first device 100 determines the sample portion of the media, step 230. As described above, in some embodiments, the sample of the media need not be pre-defined. Instead, a predetermined length of the media may automatically be selected from the complete media. For example, a sound clip from an audio work may be determined, e.g. first 60 seconds of a song, first chapter of an audio book, random 45 seconds, or the like. Additionally, for a TV show, a short feature, or a movie, a clip may include a first minute, a first five minutes of the media, or the like. Because the processing power of first device 100 is expected to be low in various embodiments, selection of a pre-determined amount of the media from the beginning of the media data may be desirable.

In the future, if the processing power of first device 100 increases, transcoding of the media clip may also be performed. For example, types of transcoding that is contemplated includes, reducing the bit-rate of the media for the media clip, reducing the bit-depth of the media, reducing the image resolution of the media, and the like. In other embodiments, watermarking of video, audio, and images may also be performed.

In some embodiments of the present invention, a pre-defined “pre-roll” message may be appended to the sample media clip, step 240. The “pre-roll” may announce where the following sample media clip may be purchased, e.g. the media store associated with media server 120. For example, a pre-roll may be: “If you want to hear more, the entire work may be easily purchased at the iTunes store, by merely clicking on the displayed link.” In other embodiments, the pre-roll may be other types of advertisements. For example, an advertisement may be: “Are you getting all you can from your media player? Come see all the media players available from Creative by following this link: www.creativelabs.com.” In still other embodiments, the “pre-roll” may be recorded or defined by the user. For example, the user may record their own pre-roll such as “Hi, this is Katrina. You're listening to my band Heat. Hear my band live at Zanzibar Grill, Saturdays 11 until 12; or “Hello, this is Nikolle. Hope you like my music. Drop me a line at: Nikolle aol.com.”

In various embodiments, the sample of the media is pre-defined and downloaded into first device 100, as described above. In such embodiments, first device 100 may not perform the task of determining the appropriate sample from the media of step 230. Additionally, in various embodiments, the pre-defined sample of the media may already include a pre-roll message, as discussed above, thus a pre-roll of step 240 may not be added.

Next, in FIGS. 2A-D, additional data associated with the media may be combined with the sample media into a transmission data package, step 250. In various embodiments, the additional data associated with the media may include a media identifier (e.g. filename), a URL, or a link to the entire media in a media store associated with media server 120.

As mentioned above, in one embodiment, the media identifier may simply be a unique identifier associated with the media in the media store. For example, the unique identifier may be a track number; a catalog number; serial number; name of the artist and track; name of the author and book; name of the show and episode number; or the like.

In one embodiment, if a link is used, the link may be a pre-formed link (e.g. URL) that includes a identifier associated with the media as well as an identifier associated with user 170, discussed above. In various embodiments, the concept of identifiers of a user included within a URL is similar to the concept of affiliate programs.

In FIGS. 2A-D, once the transmission package is completed, first device 100 requests second device 110 to receive the package, step 260. In response to the request, user 180 user may again select the share button, to accept delivery of the transmission package, step 265. This initiates the downloading (e.g. streaming) of the transmission package, step 270. As discussed above, the transmission package may be delivered across any type of communication channel.

In various embodiments, step 265 may be desirable to reduce the possibility that second device 110 will receive unwanted media samples. In other embodiments, step 265 need not be specifically performed. In such cases, a user may be interested in listening to or watching a media from anyone or any source, and her device may allow for downloads of media samples without specific authorization. In still other embodiments, user 180 may select or reset an option on second device 110 as to whether step 265 is performed or not.

In various embodiments, after the download is complete, step 270, the ad hoc communications channel between first device 100 and second device 110 need not be maintained.

Next, user 180 may watch/listen to the sample media clip, and may view the additional data of the transmission package, step 275. For example, the user may listen to a sample music clip, view the album art, and view the name of the singer and the track; the user may watch a trailer to a movie, and view positive critics' reviews; and the like. In some embodiments, user 180 need not watch/listen to the sample media clip, but may simply proceed to the next steps.

In some embodiments, after listening/viewing the sample media clip, user 180 may eventually desire to purchase the media or to delete the sample media clip, step 280.

In various embodiments if second device 110 may communicate with media server 120 via wireless mechanisms, e.g. WiFi, 802.11, CDMA, step 285, the following steps may be performed: In some embodiments, when user 180 desires to purchase the full media, user 180 may select or click on the link or an icon associated with the media, displayed on second device 110, step 290. As discussed above, the link, icon, or the like is typically provided by first device 100.

In response to the selection of the link, icon, or the like, second device 110 may be connected with the music store of media server 120, or the like. More specifically, using the media identifier (in some embodiments, embedded in the link), additional information about the media is determined and provided from media server 120 back to second device 110 for display, step 300. The additional information may include purchase options for the entire media for user 180, other related media user 180 may be interested in, and the like. Examples of other additional information may be seen on current on-line music stores such as MusicMatch, iTunes, and the like.

In various embodiments, user 180 may purchase the media from the media store using conventional purchasing processes, e.g. logging-in, providing a credit card, etc., step 310. In some embodiments, after purchase of the media, the entire media is downloaded onto second device 110 via same communications channel, step 320. Similar to step 200, additional data may also be provided to device 110.

In various embodiments where second device 110 communicates via intermediary devices 150 or 160, the following steps may be performed: In some embodiments, when user 180 desires to purchase the full media, user 180 connects or docks second device 110 with intermediary devices 150, 160, or the like. Next, based upon the URL or link provided from first device 100, discussed above, the link, icon, or the like is typically provided by first device 100 to the intermediary device, step 330.

In response to the link, icon, URL or the like, the intermediary device may be connected with the music store of media server 120, or the like. More specifically, using the media identifier (in some embodiments, embedded in the link), additional information about the media is determined and provided from media server 120 back to the intermediary device, step 340. The additional information may include purchase options for the entire media for user 180, other related media user 180 may be interested in, and the like.

In various embodiments, user 180 may purchase the media from the media store using conventional purchasing processes, e.g. logging-in, providing a credit card, etc., step 350. In some embodiments, after purchase of the media, the entire media is downloaded to the intermediary device, step 360. Similar to step 200, additional data may also be provided. Next, the entire media and the additional data may be uploaded to second device 110 via wired (e.g. USB cable), wireless channels (802.11x), Bluetooth, or the like.

In some embodiments of the present invention, after the purchase of the entire media by user 180, user 170 may be compensated in the same manner affiliates are compensated for directing shoppers to web stores, step 380. In embodiments of the present invention, various methods for rewarding user 170 for causing the media to be purchased are contemplated. For example, the account of user 170 in the music store may be credited 5 cents for every purchase. As another example, the user may be credited with a point for every purchase, where points may be redeemed for gifts, free downloads, or the like. As still another example, frequent flyer miles may be credited to user 170. In light of the present disclosure, one of ordinary skill in the art will recognize many other types of reward or reputation systems may be implemented as embodiments of the present invention. For example, in some embodiments, the amount of reward may vary with the type of media, popularity of the media, or the like. For example, for older music, the reward may be larger; for more expensive media, (e.g. downloads of an audio book) the credit may be larger; or the like.

Many changes or modifications are readily envisioned. In light of the above disclosure, one of ordinary skill in the art would recognize that many variations may be implemented based upon the discussed embodiments. In various embodiments, first device 100 and second device 110 may be embodied as portable music players, portable video players, digital cameras, computers, cell phones, personal digital assistant (PDA), or other devices which may store and output media data.

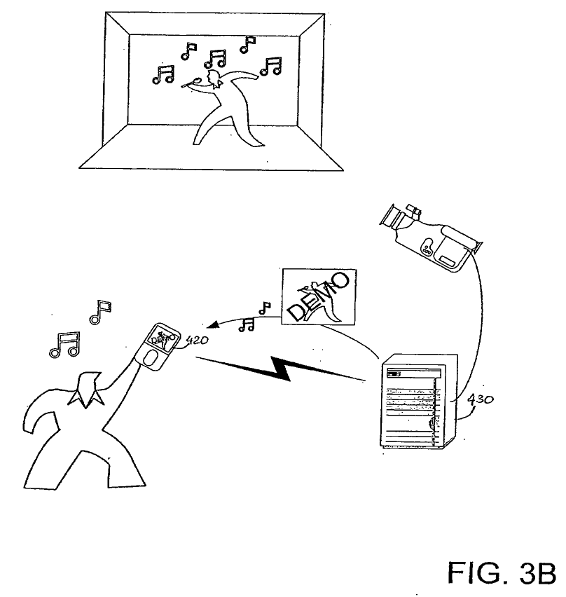

The capabilities of embodiments described above may be implemented on similar or different platforms. In some configurations, first device 100 and second device 110 may be the same model of device from a manufacturer; may be different models of devices from a manufacturer; may be from different manufacturers; or the like. For instance, as illustrated in FIG. 3A, a user of a music player 400 electronically (may be anonymously) requests a driver of a car 410 to share the song they are listening to; the driver provides a sample of the music using the techniques described above; and the user accepts the sample download.

In the example in FIG. 3B, after a concert or theatrical show, the user of a smart (cell) phone 420 electronically requests the producer 430 of the show for a sample of the show (for example, by pressing an appropriate “share” request button; in response, producer 430 may provide a sample video/audio clip from the live performance; and the user accepts the clip. In various embodiments, producer 430 may configure a system such that all requests to share media are automatically provided. This embodiment would be useful for producer 430 to promote sales of audio or video of the entire performance, or to promote other users to see the show.

In another example of FIG. 3B, after an event, a videographer or a photographer may share samples of his work to a user of a PDA 420 using the techniques described above. For example, the photographer may select a share button on their camera that causes a down-sized image or video clip to be electronically communicated to PDA 420, along with contact information of the videographer or photographer, without the use of e-mail or the like. In other embodiments, the image or video clip may be watermarked in addition to or instead of being down-sized, or the like. In various embodiments, the contact information may include photographer's name, website address, image URL, or the like.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A method for a portable audio player comprises:
requesting from a remote portable audio player a sample of an audio track stored on the remote portable audio player;
receiving the sample of the audio track and an identifier associated with the audio track from the remote portable audio player, wherein the sample of the audio track is determined in the remote portable audio player in response to the audio track, and wherein the sample of the audio track is less than all of the audio track;
purchasing the audio track from an audio server in response to the identifier associated with the audio track; and
downloading the audio track from the audio server.

2. The method of claim 1 wherein downloading the audio track from the audio server comprises downloading the audio track from the audio server using a communications channel selected from a group consisting of: wireless, 802.11x, WiFi, Bluetooth, CDMA, GSM.

3. The method of claim 1 wherein receiving the sample of the audio track comprises receiving the sample of the audio track using a communications channel selected from a group consisting of: wireless, 802.11x, WiFi, Bluetooth, CDMA, GSM.

4. The method of claim 3 wherein the audio track is selected from a group consisting of: an audio book, a lecture, a sports recording.

5. The method of claim 3 wherein the method includes
comprises receiving an identifier associated with a user of the remote portable audio player;
wherein purchasing the audio track from the audio server comprises:
providing the audio server with the identifier associated with the audio track; and
providing the audio server with the identifier associated with the user of the remote portable audio player.

6. The method of claim 5 wherein an account of the user of the remote portable audio player in the audio server is credited in response to the audio track being purchased.

7. A method for a portable media player comprises:
receiving a selection of a button on the portable media player by a user of the portable media player;
determining a media track in response to the selection of the button;
determining a sample media track from the media track in response to the selection of the button; and
transmitting the sample media track, but not the media track, to a remote portable media player.

8. The method of claim 7 wherein transmitting the sample media track comprises transmitting the sample media track to the remote portable media player using a communications channel selected from a group consisting of: wireless, 802.11x, WiFi, Bluetooth, CDMA, GSM.

9. The method of claim 8 further comprising transmitting an identifier associated with the media track to the remote portable media player.

10. The method of claim 9
wherein the media track comprises an audio track; and
wherein the identifier is selected from a group consisting of: a performer of the audio track, a title of the audio track, a catalog number, a composer of the audio track.

11. The method of claim 9 further comprising transmitting an identifier associated with the user of the portable media player.

12. The method of claim 11 wherein the identifier associated with the media track and the identifier associated with the user are combined into a pre-formed link.

13. The method of claim 8 wherein the button on the portable media player is selected from a group consisting of: dedicated hardware button, software defined hardware button, software defined icon on a display of the portable media player.

14. A portable media player comprises:
a memory configured to store a media file;
a wireless transmitter portion configured to transmit data to a remote portable media player;
a user-selectable input configured to determine a user selection; and
a processor coupled to the memory, the wireless transmitter, and the user-selectable input, wherein the processor is configured to determine a sample portion of the media file in response to a selection by the user of the user-selectable input, and wherein the processor is configured to output the sample portion of the media file, but not the media file, to the wireless transmitter portion in response to the selection of the user-selectable input.

15. The portable media player of claim 14 further comprising:
a wireless receiver portion configured to receive data including a request for the media file from the remote portable media player; and
a display portion configured to display a graphic request for the media file in response to the request from the remote portable media player.

16. The portable media player of claim 14 wherein the user-selectable input is selected from a group consisting of: a dedicated hardware button, a software defined functionality hardware button, a user-selectable icon on the display portion.

17. The portable media player of claim 16 wherein the processor is also configured to provide an identifier associated with the media file and an identifier associated with the user to the wireless transmitter portion.

18. The portable media player of claim 14 further comprising a wireless receiver portion configured to receive data from the remote portable media player comprising a sample portion of a remote media file stored in the remote portable media player.

19. The portable media player of claim 18 wherein the data from the remote portable media player also comprises an identifier associated with the remote media file.

20. The portable media player of claim 19 wherein the processor is configured to download the remote media file from a media server in response to the identifier associated with the remote media file.
